(19) United States
(12) Patent Application Publication
(10) Pub. No.: US 2007/0145202 A1
(43) Pub. Date: Jun. 28, 2007

(54) Musical instrument telescopic supporting bar with an adjusting device

(76) Inventor: Wu-Hong Hsieh, Lu Chou City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/316,707

(22) Filed: Dec. 27, 2005

(51) Int. Cl. F16M 11/00

(52) U.S. Cl. 248/161

(57) ABSTRACT

A musical instrument supporting bar with an adjusting device has a cam connected to an end of an inner tube of the supporting bar, which is mounted rotatably and slidably in an outer tube, and a collar mounted around the cam. The cam has an eccentric rod formed longitudinally. A collar is mounted around the eccentric rod, and the cam and the collar are mounted slidably and rotatably in the outer tube. When the inner tube is rotated relative to the outer tube, the eccentric rod is pressed against or released from an inner wall of the outer tube so that the relative position of the inner tube and outer tube can be adjusted conveniently.

### BACKGROUND OF THE INVENTION

1. Field of the Invention

The present invention relates to a telescopic supporting bar, and more particularly to a telescopic supporting bar with an adjusting device that can adjust the length of the supporting bar for a musical instrument stand.

2. Description of Related Art

Many different types of musical instruments are mounted respectively on supporting bars of music stands. The music stands have supporting bars with different lengths to accommodate the needs of different users and musical instruments of different sizes.

With reference to FIGS. 7 and 8, a first embodiment of a conventional supporting bar mounted in a base (not numbered) is composed of an outer tube (41), a compression bushing (43), an inner tube (42) and a fastening device (45).

The outer tube (41) has an inner diameter (not numbered), a lower end (not numbered), an upper end (not numbered) and an exterior thread (411). The lower end is mounted in the base. The exterior thread (411) is formed around the upper end of the outer tube (41).

The inner tube (42) is mounted slidably in the outer tube (41) and has an inner diameter (not numbered), an upper end (not numbered) and a lower end (not numbered). The outer diameter of the inner tube (42) is slightly smaller than inner diameter of the outer tube (41).

The compression bushing (43) is mounted in the upper end of the outer tube (41) and has an outer end (not numbered) and a compression ring (44). The compression ring (44) is formed integrally on the outer end of the compression bushing (43), is a split or segmented ring, has an inner end (not numbered) and an outer end (not numbered) and is tapered inward from the inner end to the outer end.

The inner tube (42) is mounted slidably through the compression bushing (43) and in the outer tube (41) and has a lower end (not numbered) and an upper end (not numbered). The upper end of the inner tube (42) attaches to and holds a musical instrument.

The fastening device (45) is a hollow sleeve, is connected to the upper end of the outer tube (41), is mounted slidably around the inner tube (42) and has a lower end (not numbered), an upper end (not numbered), a lower inner wall (not numbered), an upper inner wall (not numbered) and an interior thread (451). The upper inner wall is tapered inward from the lower end to the upper end so the upper end abuts and slides on the inner tube (42). The interior thread (451) is defined in the lower inner wall and screws onto the exterior thread (411) on the outer tube (41). When the fastening device (45) is screwed onto the outer tube (41), the upper inner wall (452) of the fastening device (45) squeezes the compression ring (44) against the inner tube (42) to hold the inner tube (42) in position relative to the outer tube (41).

To adjust the height of the supporting bar (40), the fastener device (45) is unscrewed until the upper inner wall releases the compression ring (44) from the inner tube (42). The inner tube (42) is moved in the outer tube (41) until the upper end of the inner tube (42) is at the desired height, and the fastening device (45) is screwed tightly onto the outer tube (41) to squeeze the compression ring (44) against the inner tube (42) and hold the inner tube (42) in place relative to the outer tube (41). However, loosening and tightening the fastening device (45) and holding the inner tube (42) in position is inconvenient for one person.

With reference to FIGS. 9 and 10, a second embodiment of a conventional supporting bar (50) mounted in a base (not numbered) was developed to mitigate the problem with the first embodiment and comprises an outer tube (51), an inner tube (52) and a fastening device (60).

The outer tube (51) has an inside surface (not numbered), a lower end (not numbered), an upper end (not numbered) and a positive stop (not numbered). The lower end is mounted in the base. The positive stop is formed on and extends in from the upper end.

The inner tube (52) is mounted slidably in the upper end of the outer tube (51) and has an upper end (not numbered), a lower end (not numbered) and an end plug (521). The upper end of the inner tube (52) attaches to and holds a musical instrument. The lower end is mounted slidably through the positive stop at the upper end of the outer tube (51) and inside the outer tube (51). The end plug (521) is mounted in and protrudes from the bottom end of the inner tube (52) and has an upper end (not numbered) and a lower end (not numbered). The upper end of the plug (521) is connected securely to the lower end of the inner tube (52). The lower end is tapered outward, abuts and slides on the inside surface of the outer tube (51) to hold the inner tube (52) coaxially relative to the outer tube (51) and selectively abuts the positive stop at the upper end of the outer tube (51) to keep the inner tube (52) from inadvertently pulling out of the outer tube (51).

The fastening device (60) is connected to the upper end of the outer tube (51), is mounted slidably around the inner tube (52) and has a base (61), a compression brake (64), a lever (62) and a spring (63).

The base (61) is connected to the upper end of the outer tube (51) and has a bottom end (not numbered), a top end (not numbered), a longitudinal segmented through hole (not numbered), a protruding side (not numbered), an actuating recess (not numbered) and a transverse hole (611).

The longitudinal segmented through hole has a lower segment (not numbered) and an upper segment (not numbered). The lower segment has an inside diameter (not numbered) corresponding to the outer tube (51) and mounts securely on the upper end of the outer tube (51). The upper segment has an inside diameter (not numbered), is formed coaxially with the lower segment and holds the upper tube (52).

The protruding side extends radially out from the base (61).

The actuating recess is formed longitudinally in the protruding side of the base (61) parallel to the longitudinal segmented through hole and has a top end (not numbered), a bottom end (not numbered) and a spring recess (not numbered). The spring recess is formed in the actuating recess near the bottom end.

The transverse hole (611) is formed in the actuating recess near the top end and communicates with the upper segment of the longitudinal segmented through hole.

The compression brake (64) is mounted slidably in the transverse hole (611) and selectively presses against the inner tube (52) to hold the inner tube (52) in place relative to the outer tube (51).

The lever (62) is mounted pivotally in the actuating recess, presses the compression brake (64) against the inner tube (52) and has an inside surface (not numbered), a top end (not numbered), a bottom end (not numbered), an upper recess (not numbered) and a lower recess (not numbered). The upper recess is formed in the inside surface near the top end of the lever (62) and is mounted on and presses the compression brake (64) against the inner tube (52).

The spring (63) is mounted in the spring recess in the actuating recess of the base (61) and the lower recess in the inside surface of the lever (62) and pivots the bottom end of the lever (62) out so the top end of the lever (62) presses the compression brake (64) into the transverse hole in the base (61) and against the inner tube (52). The inner tube (52) is released so it can be adjusted by squeezing the bottom end of the lever (62) inward. After the inner tube (52) has been adjusted, the lever (62) is released, and the spring (63) pushes the lever (62) that pushes the compression brake (64) against the inner tube (52) again.

However, the adjustment requires that the spring (63) always be compressed. Therefore, the spring (63) must be very strong so it will press the lever (62) hard enough to hold the inner tube (52) in place. Consequently, the user must apply a large force to the lever (62) to adjust the height of the second conventional supporting bar (50).

Therefore, the invention provides an adjusting device for a musical instrument supporting bar to mitigate or obviate the aforementioned problems.

### SUMMARY OF THE INVENTION

The main objective of the present invention is to provide a musical instrument supporting bar with an adjusting device that has simple a simple structure and is easy to operate.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a musical instrument stand with an adjusting device in accordance with the present invention;

FIG. 2 is an exploded perspective view of the adjusting device in FIG. 1;

FIG. 3 is an operational side view in partial section of the adjusting device in FIG. 2 in a position to adjust the height of the musical instrument stand;

FIG. 4 is an operational side view in partial section of the adjusting device in FIG. 2 in a position to hold the height of the musical instrument stand;

FIG. 5 is a cross sectional top view of the adjusting device in FIG. 3;

FIG. 6 is a cross sectional top view of the adjusting device in FIG. 4.;

FIG. 7 is a perspective view of a conventional supporting bar in accordance with the prior art;

FIG. 8 is an enlarged perspective view in partial section of the conventional supporting bar in FIG. 7;

FIG. 9 is a perspective view of another conventional supporting bar in accordance with the prior; and

FIG. 10 is an enlarged side view in partial section of the supporting bar in FIG. 9.

### DETAILED DESCRIPTION OF THE PREFERRED EMBODIMENT

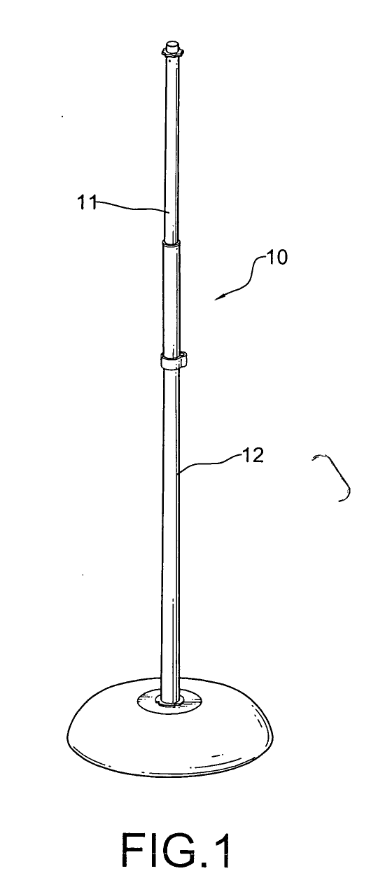

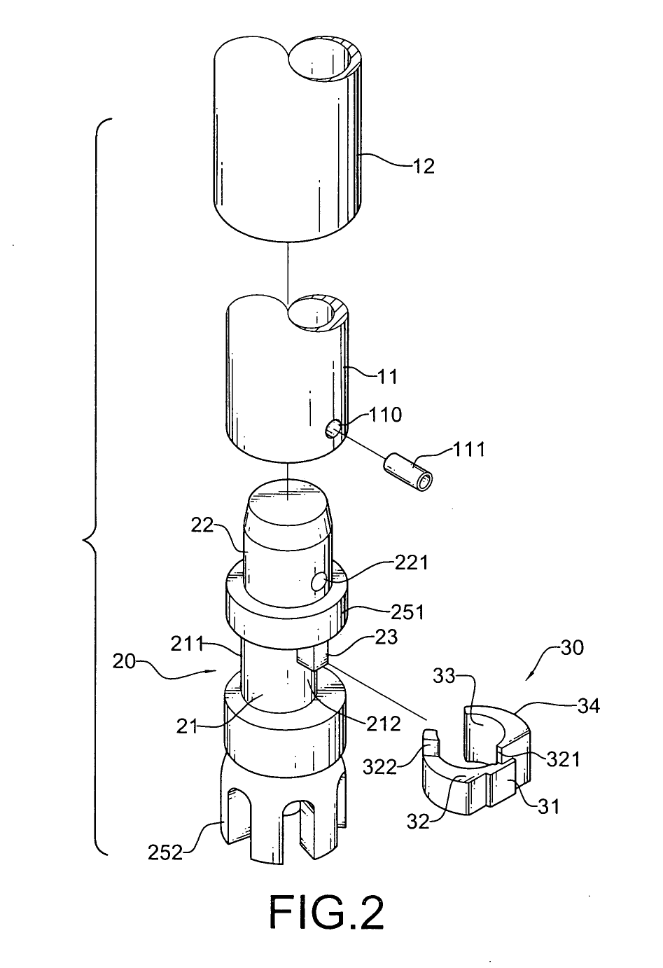

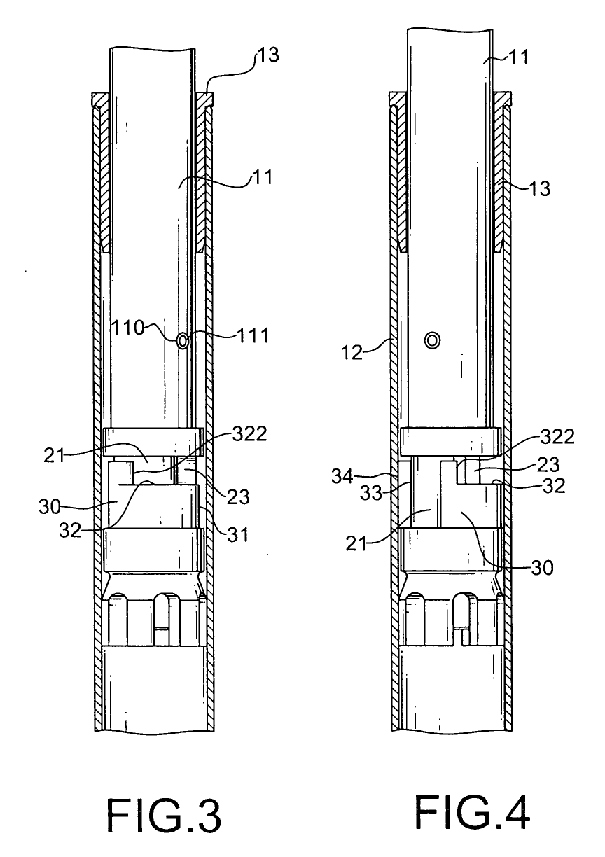

With reference to FIGS. 1-3, a telescopic supporting bar in accordance with the present invention is mounted in and extends up from a base and has an outer tube (12), a bushing (13) and an inner tube (11) and the adjusting device.

The outer tube (12) is mounted upright in the base and has an upper end, a lower end and an inside surface. The lower end is mounted in the base.

The bushing (13) is mounted in the upper end of the outer tube (12).

The inner tube (11) is mounted slidably through the bushing (13) inside the outer tube (12) and has an upper end, a lower end, a sidewall and an optional anti-rotation element. The lower end is mounted through the bushing (13) inside the outer tube (12). The anti-rotation device is formed in the lower end of the inner tube (11) and may be implemented with a key, a keyway or a mounting hole (110).

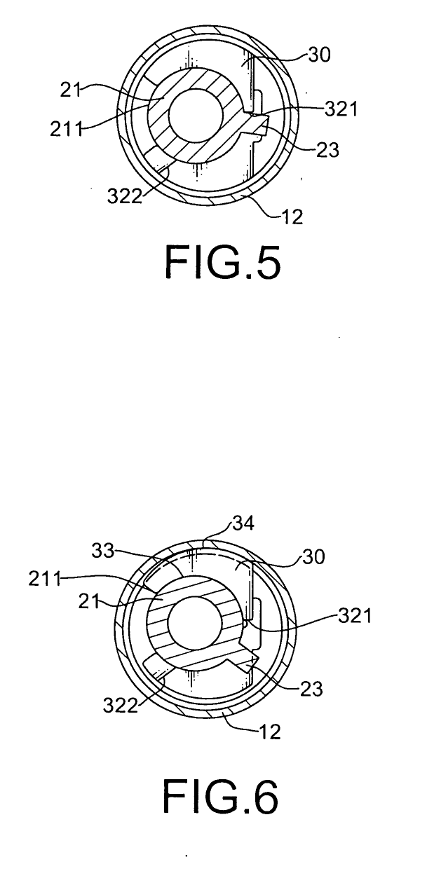

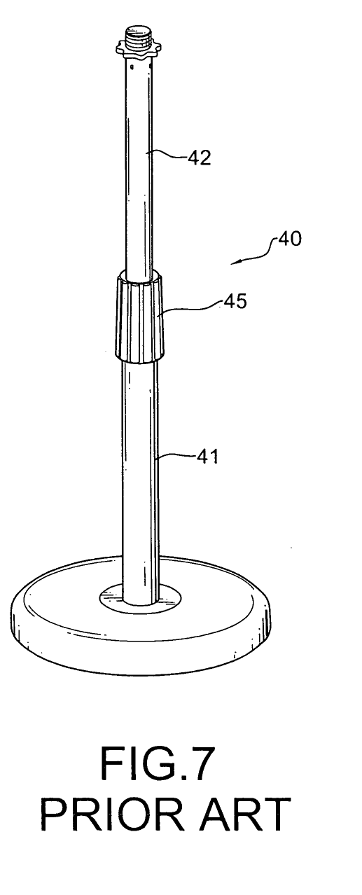

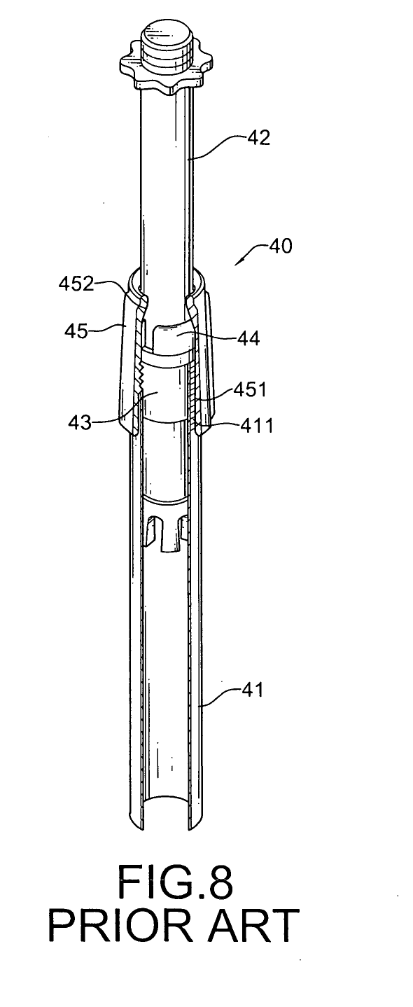

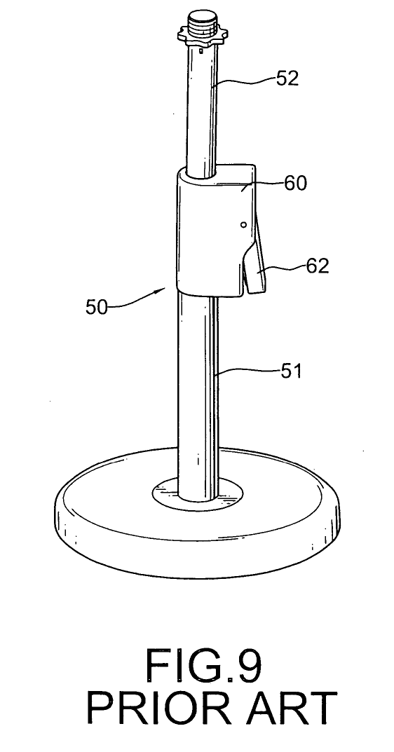

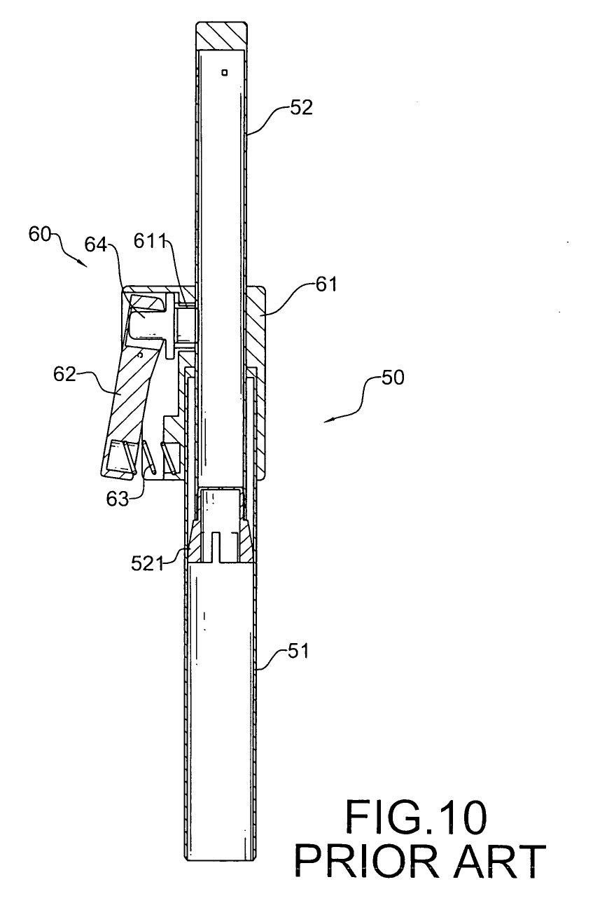

With further reference to FIGS. 4 and 5, the adjusting device comprises a cam (20) and a collar (30). The cam (20) is mounted in and protrudes down from the lower end of the inner tube (11) and has a top end, a bottom end, an optional upper rod (22), an eccentric rod (21), an upper alignment ring (251), a lower alignment ring and stabilizer (252) and an optional key (23).

The upper rod (22) is integrally formed on and protrudes concentrically up from the top end of the cam (20), is mounted securely in the inner tube (11) and has a side and an anti-rotation element. The anti-rotation element corresponds to and engages the anti-rotation device in the inner tube (11) to keep the cam (20) from rotating relative to the inner tube (11). The anti-rotation element may be implemented with a keyway, a key or a blind hole (221) and a pin (111). When the anti-rotation element is implemented with a blind hole (221) and a pin (111), the blind hole (221) is formed radially in the side of the upper bar (22) and aligns with the mounting hole (110) in the inner tube (11). The pin (111) is mounted in the mounting hole (110) and the blind hole (221) to keep the cam (20) from rotating relative to the inner tube (11).

The eccentric rod (21) is formed eccentrically on and protrudes down from the upper rod (22) at a joint and has a bottom end, a radially protruding lobe (211) and a recessed gap (212). The recessed gap (212) is formed below the upper rod (22) opposite to the protruding lobe (211).

The upper alignment ring (251) is mounted rotatably around the joint between the upper rod (22) and the eccentric rod (21) and is mounted slidably in the outer tube (12).

The lower alignment ring and stabilizer (252) is connected rotatably to the bottom end of the eccentric rod (21) and is mounted slidably in the outer tube (12).

The key (23) is mounted on and protrudes out radially from the eccentric rod (21) in the gap (212).

The collar (30) is mounted around the eccentric rod (21) inside the outer tube (12), selectively presses against the inside surface of the outer tube (12) to hold the inner tube (11) in position relative to the outer tube (12) and has a top, an open end, a flat (31), a locking arm (321), a mounting arm (322) and an optional actuating recess (32).

The open end corresponds to the lobe (211) on the eccentric rod (21).

The flat (31) is opposite from the open end.

The locking arm (321) extends from the flat (31) toward the open end, is tapered toward the open end, is mounted slidably against the eccentric rod (21), selectively presses against the inside surface of the outer tube (12) to hold the inner tube (11) in position relative to the outer tube (12) and has a curved inner wall (33) and a curved outer wall (34). The curved inner wall (33) is mounted rotatably against the eccentric rod (21). The curved outer wall (34) selectively presses against the inside surface of the outer tube (12) to hold the inner tube (11) in position relative to the outer tube (12) when the eccentric rod (21) is rotated by turning the inner tube (11).

The mounting arm (322) extends from the flat (31) toward the open end, is formed opposite to the locking arm (321) and is mounted slidably against the eccentric rod (21) to hold the collar (30) on the eccentric rod (21).

The actuating recess (32) is defined between the locking and the mounting arms (321, 322) in the top of the collar (30) and holds the key (23) inside. With further reference to FIG. 6, the lobe (211) presses against the curved arcuate inner wall (33) of the locking arm (321) when the key (23) is rotated in the actuating recess (32) toward the mounting arm (322) and presses the curved outer wall (34) against the inside surface of the outer tube (12). Rotating the key (23) in the opposite direction releases the locking arm (321) from the inside surface of the outer tube (12) so the inner tube (11) can be adjusted. With such an adjusting device, to adjust the musical instrument supporting bar is easy.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A musical instrument telescopic supporting bar having
an outer tube having an upper end, a lower end and an inside surface;
a bushing mounted in the upper end of the outer tube;
an inner tube mounted slidably through the bushing inside the outer tube and having
an upper end;
a lower end mounted through the bushing inside the outer tube; and
a sidewall; and
an adjusting device mounted between the inner tube and the outer tube and comprising:
a cam mounted in and protruding down from the lower end of an inner tube and having
a top end;
a bottom end;
an upper rod integrally formed on and protruding concentrically up from the top end of the cam, mounted securely in the inner tube and having a side;
an eccentric rod formed eccentrically on and protruding down from the upper rod at a joint and having
a bottom end;
a radially protruding lobe; and
a recessed gap formed below the upper rod opposite to the protruding lobe;
an upper alignment ring mounted rotatably around the joint between the upper rod and the eccentric rod and mounted slidably in the outer tube;
a lower alignment ring and stabilizer connected rotatably to the bottom end of the eccentric rod and mounted slidably in the outer tube; and
a key mounted on and protruding out radially from the eccentric rod in the gap; and
a collar mounted around the eccentric rod inside the outer tube, selectively presses against the inside surface of the outer tube to hold the inner tube in position relative to the outer tube and having
a top;
an open end corresponding to the lobe on the eccentric rod;
a flat opposite from the open end;
a locking arm extending from the flat toward the open end, being tapered toward the open end, mounted slidably against the eccentric rod, selectively pressing against the inside surface of the outer tube to hold the inner tube in position relative to the outer tube and having
a curved inner wall mounted rotatably against the eccentric rod; and
a curved outer wall selectively pressing against the inside surface of the outer tube to hold the inner tube in position relative to the outer tube;
a mounting arm extending from the flat toward the open end, formed opposite to the locking arm and mounted slidably against the eccentric rod to hold the collar on the eccentric rod; and
an actuating recess defined between the locking and the mounting arms in the top of the collar and holding the key.

2. The adjusting device claimed in claim 1, wherein
the cam further has a key mounted on and protruding out radially from the eccentric rod in the gap; and
the collar further has an actuating recess defined between the locking and the mounting arms in the top of the collar and holding the key.

3. The adjusting device claimed in claim 1, wherein
the inner tube has an anti-rotation device formed in the lower end of the inner tube; and
the upper rod on the cam has an anti-rotation element corresponding to and engaging the anti-rotation device in the inner tube to keep the cam from rotating relative to the inner tube.

4. The adjusting device claimed in claim 3, wherein
the anti-rotation device on the inner tube is a mounting hole; and
the anti-rotation element on the upper rod comprises:
a blind hole formed radially in the side of the upper rod and aligning with the mounting hole in the inner tube; and
a pin mounted in the mounting hole and the blind hole to keep the cam from rotating relative to the inner tube.
